(19) United States
(12) Patent Application Publication
(10) Pub. No.: US 2006/0213858 A1
(43) Pub. Date: Sep. 28, 2006

(54) Irregular shaped baby bottle

(76) Inventors: Stephanie Kraus, Glendale, CA (US); Randal Ouye, La Crescenta, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/092,361

(22) Filed: Mar. 28, 2005

(51) Int. Cl. A61J 11/00; A61J 9/08; G09F 9/00

(52) U.S. Cl. 215/11.1; 215/11.6; 116/308

(57) ABSTRACT

A container, such as a baby bottle, has an hourglass shape elongated wall substantially along its length. There is an indented portion in the hourglass shape for facilitating holding of the bottle. A rim at the top of the wall is for receiving a nipple locating closure, and the indented portion extends in height for less than half of an overall height of the bottle. The bottom of the bottle is curved and blends with wall of the bottle. The bottle has an angulated profile such that a top portion of the hourglass is arched relatively towards one side of a vertical axis extending from a bottom towards the top. The indented portion of the hourglass is angulated at a non-right angular configuration relatively to a vertical axis extending from a bottom towards the top. The inside of the bottle is formed to have a blended inside curved interface between the inside of the bottom and the inside of the wall.

### RELATED APPLICATIONS

This application is related to U.S. Utility Patent Application filed on Mar. 28, 2005, entitled “MULTI-COMPARTMENT DISPENSING CONTAINER” (Docket No. 54317-040701, Express Mail Label No. EV 310 127 888 US); U.S. Utility Patent Application filed on Mar. 28, 2005, entitled “CLEANING UTENSIL FOR A FLUID CONTAINER” (Docket No. 54317-040702, Express Mail Label No. EV 310 127 891 US); U.S. Utility Patent Application filed on Mar. 28, 2005, entitled “A HANDLED DRINKING CONTAINER” (Docket No. 54317-040704, Express Mail Label No. EV 310 127 914 US); and U.S. Utility Patent Application filed on Mar. 28, 2005, entitled “BABY BOTTLE WITH ENLARGED LOWER PORTION” (Docket No. 54317-040705, Express Mail Label No. EV 310 127 928 US); all of which have been filed concurrently herewith. The contents of those applications are incorporated by reference herein.

### BACKGROUND

1. Field

This disclosure relates to baby bottle constructions. More particularly the disclosure relates to an ergonomically designed baby bottle.

2. General Background

There are numerous baby bottles on the market, with different functions and features. None of the known bottles provide the features of the present disclosure. The prior art is replete with varying baby bottle sizes and constructions. However, none of the bottles appear to address needs that arise to collectively facilitate balance, handling, and ease of feeding infants.

While the prior art constructions may be adequate for the basic purpose and function for which they have been designed, they fail to provide a simple, efficient, and practical feeding bottle. In particular, the prior art fails to disclose a bottle sized and constructed to enhance an infant's grasp of the bottle and comfort while gripping the bottle, increase control during the feeding process, and permit correct upstanding balance when not in use.

There is a need for an improved ergonomically designed baby bottle construction that simplifies feeding, and the support functions associated with this, and permits easy and convenient bottle support when not in use.

It is an object of the present disclosure to provide a baby bottle to facilitate drinking, whether the baby is in a reclining or sitting position, and to adapt for the baby as the baby develops, and at the same time making feeding an easier function for the feeding person.

### SUMMARY

A container such as a baby bottle has an irregular shape. In one form this is an hourglass shape elongated curved side wall substantially along its length. The curved wall extends upwardly generally in a convex manner from the bottom in an upwards direction. There is an indented portion in the hourglass shape for facilitating holding of the bottle. A rim at the top of the wall is for receiving a mouthpiece locating closure. The indented portion extends in height for less than half of an overall height of the bottle.

The indented portion is relatively closer towards the top of the bottle than the bottom of the bottle. The indented portion extends circumferentially in a circle about the wall. As such, the indented portion extends circumferentially about the wall in a relatively transverse sense. The indented portion of the hourglass is angulated at a non-right angular configuration relatively to a vertical axis extending from a bottom towards the top.

In one form, the bottom of the bottle is curved and blends with the side wall of the bottle. The side wall is formed by at least two portions. One portion of the wall is essentially transparent and the other portion of the wall is essentially opaque. The bottom is the essentially opaque portion.

The bottle has an angulated profile such that a top portion of the hourglass is arched relatively towards one side of a vertical axis and extends from a bottom towards the top.

The bottle has an angulated profile such that a top portion of the wall is arched relatively towards one side of a vertical axis extending from a bottom towards the top.

A base portion is provided for location with a bottom of the bottle, and the base supports the bottle in a relatively upright manner. There is a cover, and a mouthpiece locating closure. The cover is removable. The cover is curved and blends with the closure and the wall of the bottle. The mouthpiece is for a nipple, or can be for a relatively solid spout for a sipper cup.

The inside of the bottle is formed to have a blended inside curved interface between the inside of the bottom and the inside of the wall. The curved inside interface is such that there is a relatively continuous smooth curve between the wall, the interface and the bottom portions.

### DRAWINGS

The above-mentioned features and objects of the present disclosure will become more apparent with reference to the following description taken in conjunction with the accompanying drawings, wherein like reference numerals denote like elements, and in which:

FIG. 1 is a side view of a baby bottle in accordance with the disclosure.

FIG. 2 is a back view of a baby bottle in accordance with the disclosure.

FIG. 3 is an exploded perspective view of a baby bottle in accordance with the disclosure.

FIG. 4 is a top perspective view of the nipple securing portion of a baby bottle in accordance with the disclosure.

FIG. 5 is a top perspective view of a baby bottle in accordance with an alternate embodiment of the disclosure, and where there is no base.

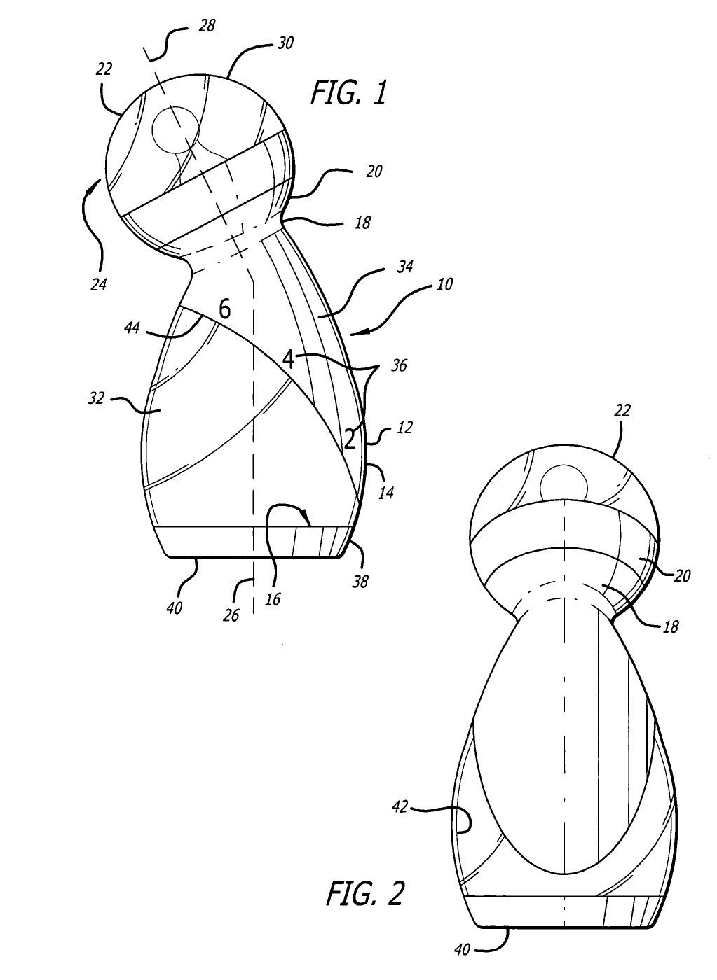

### DETAILED DESCRIPTION

The device is now described with reference to an example which is not to be considered as limiting. This is purely an illustration of the device.

One of ordinary skill in the art will understand that the present discussion is a description of exemplary embodiments only, and is not intended as limiting the broader aspects of the present disclosure, which broader aspects are embodied in the exemplary construction. A repeat use of reference characters in the present specification and drawings represents the same or analogous features or elements of the disclosure.

A baby bottle has an hourglass shape elongated wall substantially along its length. There is an indented portion in the hourglass shape for facilitating holding of the bottle. A rim at the top of the wall receives a nipple locating closure, and the indented portion extends in height for less than half of an overall height of the bottle. The indented portion is relatively closer towards the top of the bottle than the bottom of the bottle. The indented portion extends circumferentially in a circle about the wall. As such, the indented portion extends circumferentially about the wall in a relatively transverse sense. The bottom of the bottle is relatively curved and blends with the wall of the bottle. This curvature can be on the inside and/or outside of the wall and the bottom.

The wall is formed by at least two portions. One portion is essentially transparent, and the other portion is essentially opaque. The bottom wall portion is at least essentially transparent, and the portion above the bottom is essentially opaque. A line of distinction between the two portions is at an angle extending radially upwards from a location near the bottom. The line ends at a location towards the relatively lower position of the indentation.

The bottle has an angulated profile such that a top portion of the hourglass is arched relatively towards one side of a vertical axis extending from a bottom towards the top. The bottle has an angulated profile such that a top portion of the wall is arched relatively towards one side of a vertical axis extending from a bottom towards the top.

The nipple locating closure has a central area with an aperture for receiving a removable nipple. There is also a peripheral zone with a portion for a window or indicator zone when the closure is located on the top of the bottle.

The baby bottle has an elongated wall with a top of the wall for receiving a nipple locating closure. The inside of the bottle is formed to have a blended inside curved interface between the inside of the bottom of the wall and the inside of the side wall. The curved inside interface provides a relatively continuous smooth curve between the wall, the interface and the bottom portion. In one form, the outside of the bottom of the bottle is curved and blends with the curves of the wall of the bottle.

In the drawings there is shown generally a baby bottle 10 which has an hourglass shape. There is the bottom portion 12 which has a broad diameter 14 and flat base 16. There is a waist or indented section 18 at a fairly high place above the base relative to the overall size of the bottle. There is an expanded section 20 above the waist 18.

The expanded section 20 merges with a curved cover 22 to form a ball-like appearance effect for the top portion of the hourglass shaped bottle 10. The top ball-like portion generally indicated by numeral 24 is angularly arched over relative to the vertical axis 26 running through the central part of the lower portion 14 of the bottle. There is a central axis 28 running through the ball-like section 24, and the axis 28 and axis 26 intersect approximately midway or above midway in the overall height of the bottle as measured when the cover is in place. The height is determined from the base 16 to the top portion 30 of the ball-shape 24.

The bottom portion 14 includes a solid type area 32 which is substantially transparent and a solid type area 34 which is substantially opaque. There are also indicia 36 which are located on the opaque portion 34 for indicating the amount of fluid in the body portion of the bottle.

The base 16 of the bottle fits into a base element 38 so that there is a secure location with a flat portion 40 for the base 38. The base 38 also provides for stability of the bottle 10 when needed to be located in a relatively upright position.

The interface line 44 between the transparent portion 32 and opaque portion 34 runs essentially diagonally from a location towards the base to a location near the indentation or waist 18. The inside surface 42 is relatively curved between the inside of the wall 12 and inside of the bottom 16. In this manner, cleaning and handling of the inside of the bottle can be conveniently achieved.

The nipple or mouthpiece holding portion 46 is arranged with an aperture 48 through which a nipple 50 or other mouthpiece can be located. The element 46 sits on the neck 52 on top of the bottle. The element 46 can screw connect with the neck or otherwise clip in position on top of the neck. The top of the portion 46 has a lip or a ridge 53 for securing the rim 54 of the cover 22.

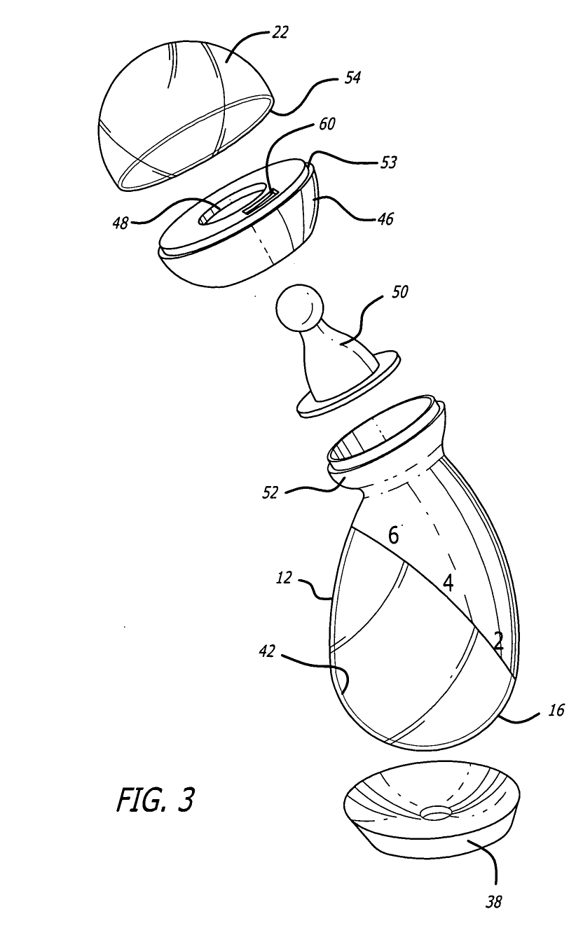

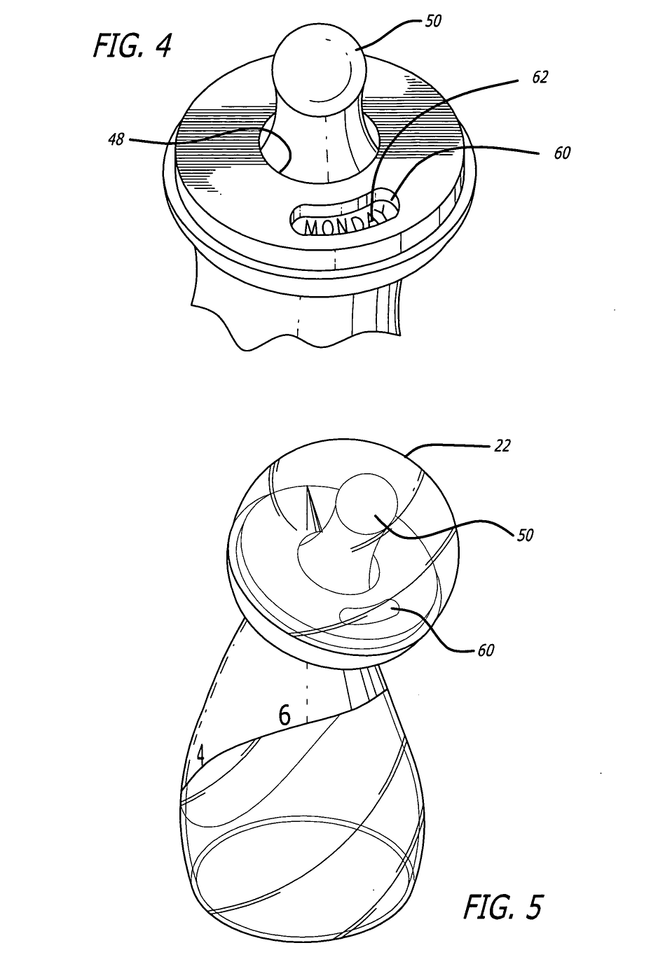

In some different embodiments of the disclosure, the base 16 for the bottle 10 can be flat and not curved as illustrated in FIG. 3. In such cases, a base element 38 may or may not be used for the bottle.

In other forms of the disclosure, instead of a smooth curved arcuate arching of the bottle, a different angulation can be formed. In yet other forms of the disclosure, there may be no angulation and the bottle can be relatively straight.

With the bottle of the disclosure, there is provided an ergonomic baby bottle with physical measurements being possible in relatively low light. The indicia that are on the bottle are formed with high contrast measurement graphics so as to facilitate reading of the bottle size. In this sense, the indicia can be formed as cut-outs in the opaque section 34. The opaque section itself can be a layer of material placed on the transparent portion of the bottle. As such, this opaque layer can be a non-slip translucent elastomer with an over-mold grip.

In the mouthpiece securing portion, there is a window or cut-out 60 through which information such as the day or date 62 can be shown in the ring being part of the mouthpiece securing portion. This ring or cap for securing the mouthpiece can locate standard nipples and nipple rings. The size of the bottle can vary as required.

An advantage of the angulation is that the bottle shape can match the sucking needs of the baby in that the flow and angle are better matched. This can effectively reduce air bubbles to the baby and thereby facilitate comfort to the baby. The opaque layer can be an overlay of different material, or a transparent material. Alternatively, there are other forms of having the opaque portion and transparent portions of the bottle or cup formed in an integrated leak-proof manner. The indicia could be formed of a material or paint with glow-in-the-dark characteristics so as to facilitate use under dim light conditions.

In some cases, instead of a curved inside, the base can be relatively flat. The bottles can be of different sizes, for instance, 5, 6 or 8 ounces.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A container comprising a wall, the wall being an hourglass baby bottle shape elongated curved wall substantially along the length of the container, the curved wall extending outwardly from the bottom of the container in a generally convex format, an indented portion in the hourglass shape for facilitating holding of the container, and a rim at the top of the wall for receiving a mouthpiece locating closure, the indented portion extending in height for less than half of the overall height of the container.

2. A container comprising a wall, the wall being an hourglass shape elongated wall substantially along the length of the container, an indented portion in the hourglass shape for facilitating holding of the container, and a rim at the top of the wall for receiving a mouthpiece locating closure, and wherein the bottom of the bottle is curved and blends with wall of the container.

3. The container of claim 2, wherein the indented portion is relatively closer towards the top than the bottom of the bottle.

4. The container of claim 1, wherein the wall is formed by at least two portions, one portion being essentially transparent and the other portion being essentially opaque.

5. A baby bottle comprising a wall, the wall being an hourglass shape elongated wall substantially along the length of the bottle, an indented portion in the hourglass shape for facilitating holding of the bottle, a rim at the top of the wall for receiving a nipple locating closure, and the bottle having an angulated profile such that a top portion of the hourglass is arched relatively towards one side of a vertical axis extending from a bottom of the bottle towards the top of the bottle.

6. The baby bottle of claim 5, wherein the bottle has a profile such that the indented portion of the hourglass is angulated at a non-right angular configuration relatively to a vertical axis extending from the bottom towards the top.

7. The baby bottle of claim 5, wherein the wall is formed by at least two portions, one portion being the bottom being at least essentially transparent, and the other portion being the portion above the bottom being essentially opaque.

8. The baby bottle of claim 5, wherein the wall is formed by at least two portions, one portion being the bottom being at least essentially transparent, and the other portion being the portion above the bottom being essentially opaque, and wherein a line of distinction between the two portions is at an angle extending from a location towards the bottom of the bottle to a position towards the indented portion.

9. The container of claim 2, wherein the wall is formed by at least two portions, one portion being the bottom and being at least essentially transparent, and the other portion being the portion above the bottom and being essentially opaque, and wherein a line of distinction between the two portions is at a angle extending from a location towards the bottom to a position towards the indented portion.

10. A baby bottle comprising a wall having an hourglass shape substantially along its length, an indented portion in the hourglass shape for facilitating holding of the bottle, a rim at the top of the wall for receiving a mouthpiece locating closure, a base portion for location with a bottom of the bottle, and the base being for supporting the bottle in a relatively upright manner.

11. A baby bottle comprising a wall having an hourglass shape substantially along its length, an indented portion in the hourglass shape for facilitating holding of the bottle, a rim at the top of the wall for receiving a mouthpiece locating closure, a mouthpiece locating closure, the closure having a central aperture for receiving a removable mouthpiece, and a peripheral zone with a portion for a window.

12. The container of claim 1, including a cover, a mouthpiece locating closure, the cover being removable, and wherein the cover is curved and blends with mouthpiece locating closure and the wall of the container.

13. The container of claim 2, wherein the indented portion extends circumferentially in a circle about the wall.

14. A baby bottle comprising an elongated wall, a top of the wall being for receiving a mouthpiece locating closure, and a bottom of the bottle being curved and blending with wall of the bottle, the curvature being such that the bottle is incapable of standing upright without external support.

15. The baby bottle of claim 14, including an indented portion in the wall, the indented portion being relatively closer towards the top than the bottom of the bottle.

16. The baby bottle of claim 14, wherein the bottle has an angulated profile such that a top portion of the wall is arched relatively towards one side of a vertical axis extending from a bottom towards the top.

17. The baby bottle of claim 15, wherein the bottle has a profile such that the indented portion of the wall is angulated at a non-right angular configuration relative to a vertical axis extending from a bottom towards the top.

18. The baby bottle of claim 14, including a base portion for location with a bottom of the bottle, the base being for supporting the bottle in a relatively upright manner.

19. The baby bottle of claim 14, including the mouthpiece locating closure, the closure having a central aperture for receiving a removable nipple, a peripheral zone with a portion for a window.

20. The baby bottle of claim 14, including a cover, a mouthpiece locating closure, the cover being removable, and wherein the cover is curved and blends with the locating closure and the wall of the bottle.

21. A baby bottle comprising an elongated wall, a top of the wall being for receiving a nipple locating closure, and a bottom portion for the wall, the inside of the bottle being formed to have a blended inside curved interface between the inside of the bottom and the inside of the wall, the curved inside interface being such there is a relatively continuous smooth curve between the wall, the interface and the bottom portions.

22. The baby bottle of claim 21, including an indented portion in the wall, the indented portion being relatively closer towards the top than the bottom of the bottle.

23. The baby bottle of claim 21, wherein the bottle has an angulated profile such that a top portion of the wall is arched relatively towards one side of a vertical axis extending from a bottom towards the top.

24. The baby bottle of claim 22, wherein the bottle has a profile such that the indented portion of the wall is angulated at a non-right angular configuration relatively to a vertical axis extending from a bottom towards the top.

25. A baby bottle comprising an elongated wall, an indented portion in the wall for facilitating holding of the bottle, a rim at the top of the wall for receiving a nipple locating closure, and the indented portion extending circumferentially about the wall in a relatively transverse sense, the wall having essentially two portions, a relatively vertical lower portion and a relatively vertically offset upper portion.

26. The baby bottle of claim 25, wherein the inside of a bottom of the bottle is curved and blends with the inside of the wall of the bottle.

27. The baby bottle of claim 25, wherein the indented portion is relatively closer towards the top than the bottom of the bottle.

28. The baby bottle of claim 25, wherein the wall is formed by at least two portions, one portion being essentially transparent and the other portion being essentially opaque.

29. The baby bottle of claim 25, wherein the bottle has an angulated profile such that a top portion of the bottle is directed relatively towards one side of a vertical axis extending from a bottom towards a top of the bottle.

30. The baby bottle of claim 25, wherein the bottle has a profile such that the indented portion of the wall is angulated at a non-right angular configuration relatively to a vertical axis extending from a bottom towards the top.

31. The baby bottle of claim 25, including a nipple locating closure, the closure having a central aperture for receiving a removable nipple, and a peripheral zone with a portion for a window when located on the top of the bottle.
